(19) United States
(12) Patent Application Publication
(10) Pub. No.: US 2005/0064060 A1
(43) Pub. Date: Mar. 24, 2005

(54) Molding apparatus for making molded plastic skins

(75) Inventors: Peter Wagner, Weichs (DE); Robert Brunner, Augsburg (DE)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTSTOFFTECHNIK GMBH, Munchen (DE)

(21) Appl. No.: 10/985,677

(22) Filed: Nov. 10, 2004

Related U.S. Application Data
(63) Continuation of application No. PCT/EP03/04688, filed on May 6, 2003.

(30) Foreign Application Priority Data
May 15, 2002 (DE) 102 21 478.6

(51) Int. Cl. B29C 41/04

(52) U.S. Cl. 425/418; 425/435

(57) ABSTRACT

A molding apparatus for making molded plastic skins includes a housing shell, and a mold shell which is movably supported on the housing shell for movement thereto and has a wall which is determinative for shaping the contour of a plastic skin. The mold shell and the housing shell define together a hollow space for throughflow of a heat-transfer medium. Flow passageways for heat transfer medium may be provided by subdividing the hollow space between the mold shell and the housing shell by means of partition walls to thereby force the heat-transfer medium to flow along a predetermined path.

### CROSS-REFERENCES TO RELATED APPLICATIONS

This application is a continuation of prior filed copending PCT International application no. PCT/EP03/04688, filed May 6, 2003, which designated the United States and on which priority is claimed under 35 U.S.C. § 120, the disclosure of which is hereby incorporated by reference, and which claims the priority of German Patent Application, Serial No. 102 21 478.6, filed May 15, 2002, pursuant to 35 U.S.C. 119(a)-(d).

### BACKGROUND OF THE INVENTION

The present invention relates, in general, to a molding apparatus for making molded plastic skins.

Nothing in the following discussion of the state of the art is to be construed as an admission of prior art.

Molded plastic skins are typically made by a heatable molding apparatus which operates in the so-called rotation process. The molding apparatus determines the contour of the skins being produced and is connected to a box which contains, for example, thermoplastic pellets. After being heated, the closed molding apparatus is caused to rotate in order to allow thermoplastic pellets to deposit and melt on the inside wall surface of the heated molding apparatus. As the molding apparatus is subsequently allowed to cool down, the thermoplastic material solidifies and the thus-formed skin can be removed.

In order to provide an effective temperature control by heating and cooling, the molding apparatus is constructed as hollow body comprised of a mold shell and a housing shell. A heating or cooling medium, such as for example oil, is conducted through the hollow space. The mold shell on which the skin is formed and which is called electroplate, is typically manufactured by a galvanic process and is made, for example, of a copper-nickel alloy. The housing shell does not assist in the shaping action so that its surface properties and material properties are subject to less demand and typically can be made of steel sheet.

In the following description, the term “heating or cooling medium” designating the medium supplied to the molding apparatus to establish an effective temperature control will be generally referred to as “heat-transfer medium”.

As a result of different coefficients of thermal expansion between the materials of the housing shell and the mold shell, the molding apparatus is subjected during cyclical heating and cooling processes to thermal stress which can lead to a fracture of the mold shell. U.S. Pat. No. 5,374,180 attempts to address the problem of thermal stress by providing the housing shell with bulges to absorb and compensate the thermal stress. Another consideration is the implementation of a quick and effective heating or cooling of the molding apparatus. U.S. Pat. No. 5,221,539 attempts to address this problem by providing a plurality of feed and discharge openings across the area of the housing shell for the heat-transfer medium. However, during a change from a heating process to a cooling process, or vice versa, the heat-transfer media, normally hot oil and cold oil, intermingle considerably, resulting in an inefficient overall operation.

For a number of reasons, the various proposals are endowed with drawbacks and shortcomings relating for example to manufacturing techniques or to the effect that is hoped to be obtained but may not always be realized.

It would therefore be desirable and advantageous to provide an improved molding apparatus to obviate prior art shortcomings and to prevent a buildup of internal stress in a simple and effective manner.

### SUMMARY OF THE INVENTION

According to one aspect of the present invention, a molding apparatus for making molded plastic skins includes a housing shell, and a mold shell which is sealingly supported on the housing shell for movement thereto and has a wall which is determinative for shaping the contour of a plastic skin, wherein the mold shell and the housing shell define together a hollow body for throughflow of a heat-transfer medium.

The present invention resolves prior art problems by constructing the mold shell and the housing shell movable relative to one another to eliminate internal thermal stress as a result of different heat expansion between the materials of the mold shell and the housing shell.

According to another feature of the present invention, the mold shell can be floatingly supported in a slideway which is connected to the housing shell. Suitably, the slideway may be constructed to include sealing elements in order to seal the hollow space of the molding apparatus against the outside.

According to another feature of the present invention, bolts may be provided for connecting the mold shell and the housing shell, such that one of the bolts seats by precision fit in a bore at one marginal area of the mold shell, whereas another one of the bolts projects through an oblong hole, thereby allowing the mold shell to expand in relation to the housing shell, while effectively maintaining a tight connection between the mold and housing shells. Suitably, a sealing assembly may be disposed between the mold shell and the housing shell.

According to another feature of the present invention, the hollow body defines an interior space which may have plural flow passageways for flow of a heat-transfer medium between an inlet and an outlet. The flow passageways inside the hollow space are constructed to force the heat-transfer medium to flow along a predetermined path in order to improve the temperature control of the molding apparatus. In this way, when a change in temperature is sought, it becomes possible, to use, for example, hot heat-transfer medium to completely expel cold heat-transfer medium from the molding apparatus, without experiencing a mingling of hot and cold heat-transfer media. Likewise, cold heat-transfer medium can be used to completely expel hot heat-transfer medium from the molding apparatus.

According to another feature of the present invention, the flow passageways may be bounded by partition walls which are connected to the housing shell but not to the mold shell. In this way, the mold shell may be replaced by another mold shell, without need for dismantling the flow passageways. Suitably, each flow passageway has its own inlet and its own outlet.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic side view, partly broken away, of one embodiment of a molding apparatus according to the present invention;

FIG. 2 is a schematic top view of another embodiment of a molding apparatus according to the present invention; and

FIG. 3 is a schematic top view of the molding apparatus of FIG. 1.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

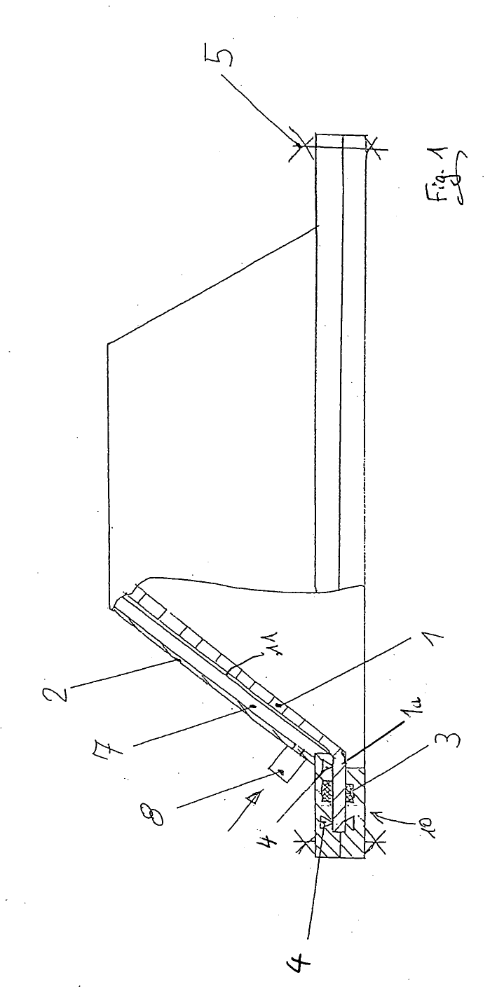

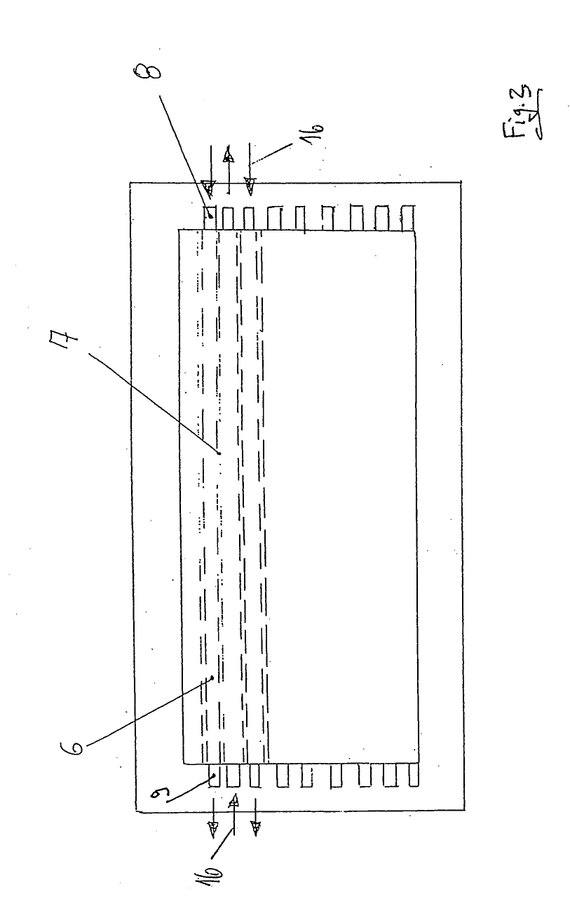

Turning now to the drawing, and in particular to FIG. 1, there is shown a schematic side view, partly broken away, of one embodiment of a molding apparatus according to the present invention, including a mold shell 1 having an inside wall surface provided for deposit thermoplastic material to melt thereon during operation and thereby shape a skin. The mold shell 1 forms together with a housing shell 2 a hollow body having a hollow interior space which is subdivided by a plurality of partition walls 7 in parallel relationship into a plurality of flow passageways 6, as shown in particular in FIG. 3. A heat-transfer medium, either hot oil or cold oil, is conducted via an inlet 8 into the hollow space.

The mold shell 1 includes a flange 1a which is supported in a slideway 10 upon the housing shell 2. The slideway 10 includes lip seals 4, whereby the lip of one lip seal 4 seals the flange 1a of the mold shell 1. Disposed between the lip seals 4 are sliding strips 3. The flange 1a of the mold shell 1 is so clamped between the sliding strips 3 as to be able to move as the mold shell 1 expands in relation to the housing shell 2 as a result of different coefficients of thermal expansion between the material of the mold shell 1 and the material of the housing shell 2. A second lip seal 4 (to the right of the sliding strips 3 in FIG. 1) provides absolute oil-tightness. Reference numeral 5 designates the provision of fastening screws for bolting the slideway 10 with integrated sealing lips 4 and sliding strips 3 together and thereby allow easy replacement, if necessary.

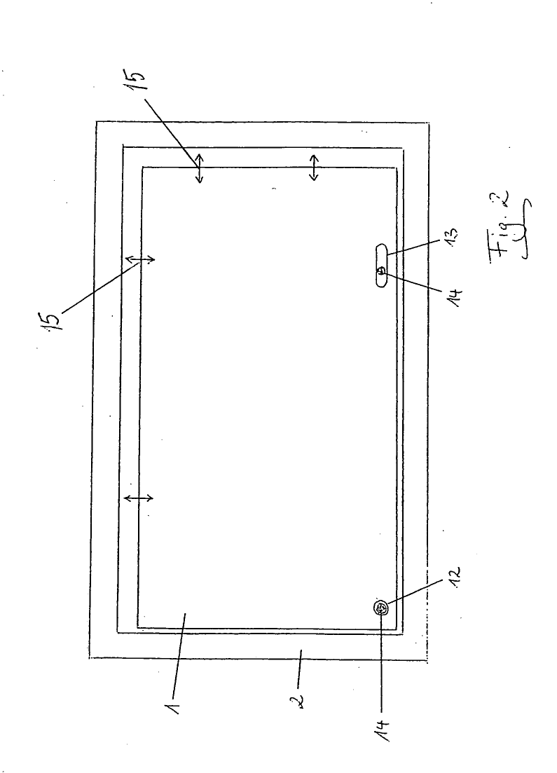

FIG. 2 shows a schematic top view of another embodiment of a molding apparatus according to the present invention. Parts corresponding with those in FIG. 1 are denoted by identical reference numerals and not explained again. The description below will center on the differences between the embodiments. In this embodiment, a thermal expansion of the mold shell 1 in relation to the housing shell 2, while maintaining a sealing support, is realized by providing the mold shell 1 with a bore 12 and an oblong hole 13 on one side at its marginal area. Snugly fitted in the bore 12 is a bolt 14, possibly with interposition of a sealing lip ring (not shown), and another bolt 14, possibly with interposition of a sealing lip ring (not shown), is received in the oblong hole 13, for connecting the mold shell 1 to the housing shell 2. In this type of support, the mold shell 1 is able to expand in both directions, as indicated by double arrows 15, while maintaining a tight connection of the mold shell 1 with the housing shell 2.

Common to both embodiments shown in FIGS. 1 and 2 is the arrangement of the partition walls 7 in the hollow space between the mold shell 1 and the housing shell 2. FIG. 3 shows in more detail the arrangement of the partition walls 7 to subdivide the hollow space between the mold shell 1 and the housing shell 2 into the flow passageways 6. Although FIG. 3 shows the partition walls 3 in parallel relationship to demarcate parallel flow passageways 6, it is, of course, also within the scope of the present invention to so configure the partition walls as to define winding flow passageways.

Each flow passageway 6 has an inlet 8 and an outlet 9. The partition walls 7 are connected to the housing shell 2 at a distance to the mold shell 1 so that a gap 11 (FIG. 1) is defined. Welding is the currently preferred method to connect the partition walls 7 to the housing shell 2. As a result of the gap 11, the mold shell 1 can easily be replaced, if need be, without requiring to dismantle the partition walls 7.

At operation, the various inlets 8 and outlets 9 are fluidly connected to a main inlet port and main outlet port, respectively, whereby the heat-transfer medium in neighboring passageways 6 flows in opposite directions, as indicated by arrows 16. Of course, the flow of heat-transfer medium may also be conducted in neighboring passageways 6 in a same direction. The passageways 6 force the heat-transfer medium to flow along a predetermined path in the hollow space of the molding apparatus so that cold heat-transfer medium, e.g. cold oil, can be completely expelled by hot transfer medium, e.g. hot oil, from the molding apparatus, or vice versa, substantially in the absence of any intermingling between cold heat-transfer medium and hot heat-transfer medium.

According to an actual implementation of a molding apparatus of the present invention, the passageways 6 have a width of up to about 50 mm. The application of such flow passageways 6 realizes a slight temperature differential of maximal ±6° C. between incoming and outgoing heat-transfer media during a temperature change. In comparison, conventional molding apparatuses, in which intermingling between the heat-transfer media takes place, exhibit a temperature differential of typically ±10° C.

The use of a molding apparatus according to the present invention for making molded plastic skins allows the selection of any suitable materials for the mold shell 1 and the housing shell 2 as a result of the free mobility between the mold shell 1 and the housing shell 2, whereby the materials can have different coefficients of thermal expansion. Therefore, the material selection may take into account particular needs, such as, e.g., surface properties and costs considerations. The subdivision of the hollow space between the mold shell 1 and the housing shell 2 into a flow passageway system realizes an effective temperature control, thereby reducing the time of the production cycles, while the material expansion as a result of the quicker changes in temperature causes no damage to the molding apparatus.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A molding apparatus for making molded plastic skins, comprising:
a housing shell; and
a mold shell which is sealingly supported on the housing shell for movement thereto and has a wall which is determinative for shaping the contour of a plastic skin, wherein the mold shell and the housing shell define together a hollow body for throughflow of a heat-transfer medium.

2. The molding apparatus of claim 1, wherein the hollow body defines an interior space having plural flow passageways for flow of a heat-transfer medium between an inlet and an outlet.

3. The molding apparatus of claim 1, and further comprising a support for floatingly mounting the mold shell in relation to the housing shell.

4. The molding apparatus of claim 1, and further comprising a slideway connected to the housing shell for support of the mold shell.

5. The molding apparatus of claim 4, wherein the slideway is constructed to include sealing elements.

6. The molding apparatus of claim 1, and further comprising bolts for connecting the mold shell and the housing shell, one of the bolts seating by precision fit in a bore at one marginal area of the mold shell, and with another one of the bolts being supported at said marginal area in an oblong hole.

7. The molding apparatus of claim 1, and further comprising a sealing assembly disposed between the mold shell and the housing shell.

8. The molding apparatus of claim 2, wherein the flow passageways are bounded by partition walls which are connected to the housing shell.

9. The molding apparatus of claim 8, wherein the partition walls are mounted to the housing shell at a distance to the mold shell to thereby define a gap between the partition walls and a confronting wall surface of the mold shell.

10. The molding apparatus of claim 2, wherein each of the flow passageways has a one of said inlet and/or a one of said outlet.
